(19) United States
(12) Patent Application Publication
(10) Pub. No.: US 2014/0123428 A1
(43) Pub. Date: May 8, 2014

(54) WIPING DEVICE

(71) Applicants: Koen Bex, Jeuk/Limburg Belgien (BE); Helmut Depondt, Kessel-Lo (BE); Dirk Herinckx, Dries-Linter (BE)

(72) Inventors: Koen Bex, Jeuk/Limburg Belgien (BE); Helmut Depondt, Kessel-Lo (BE); Dirk Herinckx, Dries-Linter (BE)

(73) Assignee: ROBERT BOSCH GMBH, Stuttgart (DE)

(21) Appl. No.: 14/130,238

(22) PCT Filed: May 22, 2012
(86) PCT No.: PCT/EP2012/059484

§ 371 Date: Dec. 30, 2013

(30) Foreign Application Priority Data
Jun. 28, 2011 (DE) 10 2011 078 200.1

(51) Int. Cl. B60S 1/38

(52) U.S. Cl. CPC B60S 1/3853
USPC 15/250.32

(57) ABSTRACT

The invention relates to a wiping device, in particular a wiping device for a motor vehicle pane, comprising a spring element (20a-20d) and a wiper blade adapter (12a-12d) that has at least one detent element (40a-40d, 42a-42d). According to the invention, the spring element (20a-20d) has at least one circular detent cavity (26a-26d, 28a-28d) in which the at least one detent element (40a-40d, 42a-42d) interlockingly engages when mounted, preventing a movement of the wiper blade adapter (12a-12d) relative to the spring element (20a-20d) in a longitudinal direction (22a-22d).

### PRIOR ART

A wiping device, in particular a wiping device for a motor vehicle pane, comprising a spring element and comprising a wiper blade adapter which has at least one latching element, is already known.

### DISCLOSURE OF THE INVENTION

The invention is based on a wiping device, in particular on a wiping device for a motor vehicle pane, comprising a spring element and comprising a wiper blade adapter which has at least one latching element.

It is proposed that the spring element has at least one round latching recess in which the at least one latching element engages in an interlocking manner in a fitted state and avoids a movement of the wiper blade adapter relative to the spring element in a longitudinal direction, thus enabling the spring element to be fastened in a particularly stable manner to the wiper blade adapter. A “spring element” is intended to be understood in this context as meaning, in particular, a spring-elastic element which has at least one extent which, in a normal operating state, is elastically alterable by at least 10%, in particular by at least 20%, preferably by at least 30% and particularly advantageously by at least 50%, and which, in particular, produces a counter-force which is dependent on an alteration of the extent and is preferably proportional to the alteration, said counter-force counteracting the alteration. A “wiper blade adapter” is intended to be understood in this context as meaning, in particular, an adapter which has a contact region with a wiper blade component and is captively connected to the wiper blade component and is provided to supply a coupling region of the wiper blade component for coupling to and/or making contact with a wiper arm adapter. A “latching element” is intended to be understood in this context as meaning, in particular, a spring-elastic element for producing a latching connection, said spring-elastic element being provided to be deflected elastically during installation. “Round” is intended to be understood in this context as meaning, in particular, free from edges and/or ellipsoidal and/or, preferably, circular. A “latching recess” is intended to be understood in this context as meaning, in particular, a recess which is provided for receiving a corresponding latching element. “Longitudinal direction” is intended to be understood in this context as meaning, in particular, a direction which extends substantially parallel to a longitudinal extent of the spring element. A “longitudinal extent” is intended to be understood in this context as meaning, in particular, a greatest possible extent. “Substantially” is intended to be understood in this context as meaning, in particular, a deviation of less than 10°, preferably less than 5°. An “extent” of an element is intended to be understood in this context as meaning, in particular, a maximum distance between two points of a vertical projection of the element on a plane. “Provided” is intended to be understood as meaning, in particular, specifically designed and/or equipped.

In a further refinement of the invention, it is proposed that, in a fitted state, the at least one latching element bears against the spring element on a side facing away from the wiper strip, thus enabling a particularly compact construction of the wiping device to be achieved.

If the at least one latching element is provided to be deflected at least substantially in a vertical direction during installation, a particularly compact design with simultaneously high operating reliability can be achieved. A “vertical direction” is intended to be understood in this context as meaning, in particular, a direction which extends at least substantially perpendicularly to the longitudinal direction and perpendicularly to a wiping direction. A “wiping direction” is intended to be understood in this context as meaning, in particular, a direction which extends parallel to a surface to be wiped and/or perpendicularly to a main orientation of a wiper strip. A “wiper strip” is intended to be understood in this context as meaning, in particular, a strip which is provided to wipe a vehicle pane.

Furthermore, it is proposed that the at least one latching element has at least two latching arms which are connected to the wiper blade and are provided to be deflected in a spring-elastic manner, and therefore the latching element can be formed particularly stably and so as to be capable of bearing a load. A “latching arm” is intended to be understood in this context as meaning, in particular, an arm which connects the latching element to the wiper blade adapter in a spring-elastic manner.

Furthermore, it is proposed that the at least two latching arms extend in a main extent at least substantially parallel to the longitudinal direction of the spring element, thus enabling a particularly simple and flat construction of the wiping device to be achieved.

Particularly high operating reliability can be achieved if the wiper blade adapter has two latching elements, the free ends of which point in directions facing away from each other.

Furthermore, it is proposed that the wiper blade adapter comprises two latching elements, the free ends of which point in directions facing each other, thus enabling a further increase in the operating reliability.

If the at least one latching element is deflectable about a pivot axis which extends parallel to a wiping direction, a particularly flat design of the wiping device can be achieved.

### DRAWINGS

Further advantages emerge from the description below of the drawing. Four exemplary embodiments of the invention are illustrated in the drawing. The drawings, the description and the claims contain numerous features in combination. A person skilled in the art will expediently also consider the features individually and put them together to form useful further combinations.

In the drawings:

FIG. 1 shows a perspective view of a wiping device according to the invention comprising a wiper blade adapter,

FIG. 2 shows a sectional illustration of a retaining element comprising a spring element of the wiping device according to FIG. 1,

FIG. 3 shows a top view of the spring element according to FIG. 2,

FIG. 4 shows a perspective view of a section of the wiper blade adapter and the spring element according to FIG. 3,

FIG. 5 shows a top view of a spring element of a further exemplary embodiment of a wiping device,

FIG. 6 shows a perspective view of a section of a wiper blade adapter with the spring element according to FIG. 5,

FIG. 7 shows a top view of a spring element of a further exemplary embodiment of a wiping device,

FIG. 8 shows a perspective view of a section of a wiper blade adapter comprising the spring element according to FIG. 7,

FIG. 9 shows a top view of a spring element of a further exemplary embodiment of a wiping device, and

FIG. 10 shows a perspective view of a section of a wiper blade adapter comprising the spring element according to FIG. 9.

### DESCRIPTION OF THE EXEMPLARY EMBODIMENTS

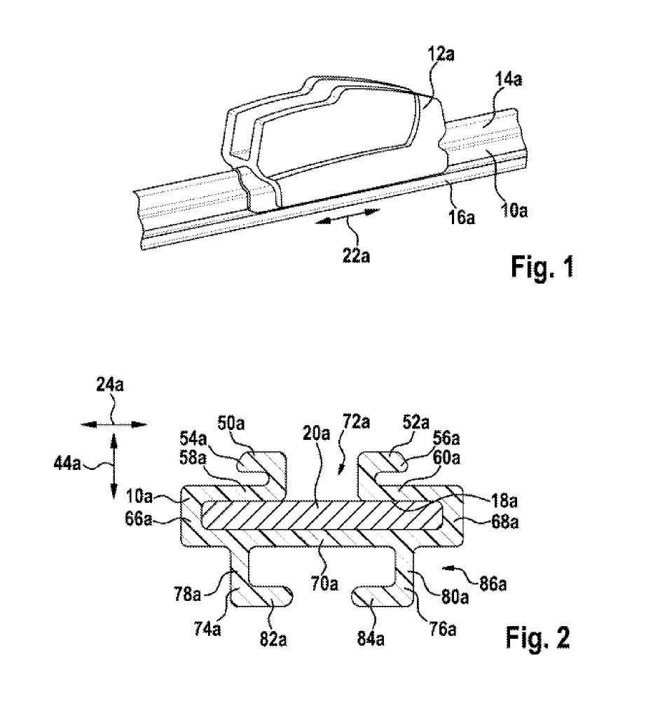

FIG. 1 shows a perspective view of a wiping device according to the invention comprising a retaining element 10a, a wiper blade adapter 12a, a wind spoiler element 14a and a wiper strip 16a in a fitted state. The wiper blade adapter 12a, the wind spoiler element 14a and the wiper strip 16a are fastened to the retaining element 10a. The wiper blade adapter 12a is provided to be coupled to a wiper arm (not illustrated). In an operating state, i.e. when the wiper arm performs a wiping movement, the wiper strip 16a is moved via the retaining element 10a over a surface (not illustrated) to be wiped. When headwind is encountered, the wind spoiler element 14a deflects said wind and presses the wiping device onto the surface to be wiped.

FIG. 2 shows the retaining element 10a which has a longitudinal guide channel 18a for guiding a spring element 20a, in a sectional illustration. The sectional plane runs perpendicularly to a longitudinal direction 22a of the retaining element 10a. The retaining element 10a has two wind spoiler fastening elements 50a, 52a. The wind spoiler fastening elements 50a, 52a are formed integrally with the retaining element 10a. The free ends 54a, 56a of the wind spoiler fastening elements 50a, 52a point in directions facing away from each other. Furthermore, the wind spoiler fastening elements 50a, 52a form two channel walls 58a, 60a which adjoin the longitudinal guide channel 18a on a side facing away from the wiper strip. The wind spoiler fastening elements 50a, 52a are designed in the shape of barbed hooks in the region of the free ends 54a, 56a thereof. In a fitted state, the ends 54a, 56a are enclosed by the wind spoiler element 14a.

For guiding the spring element 20a, side walls 66a, 68a of the longitudinal guide channel 18c are adjacent to the channel walls 58a, 60a. The channel walls 58a, 60a here enclose a right angle with the side walls 66a, 68a. Furthermore, an intermediate wall 70a which terminates the longitudinal guide channel 18a in the direction of the wiper strip 16a is arranged on the side walls 66a, 68a. The side walls 66a, 68a extend from the intermediate wall 70a in a direction remote from the wiper strip 16a. The retaining element 10a has a longitudinal opening 72a which opens the longitudinal guide channel 18a toward the wind spoiler element 14a.

Two L-shaped guide profiles 74a, 76a of the retaining element 10a are arranged on the intermediate wall 70a. The guide profiles 74a, 76a are formed integrally with the retaining element 10a. The guide profiles 74a, 76a in each case have a side guide 78a, 80a, and in each case a vertical guide 82a, 84a. The vertical guides 82a, 84a in each case enclose an angle of 90° with the side guides 78a, 80a. The side guides 78a, 80a in each case enclose an angle of 90° with respect to the intermediate wall 70a. The guide profiles 74a, 76a at their free ends of the vertical guides 82a, 84a point in directions facing each other. The guide profiles 74a, 76a and the intermediate wall 70a form a keder rail 86a, into which the wiper strip 16a is inserted in a fitted state.

The retaining element 10a is produced integrally from polyethylene in an extrusion process. A person skilled in the art will consider different synthetic materials which appear expedient in this context, such as, in particular, polypropylene, polyamide, polyvinyl chloride, polycarbonate and/or polystyrene.

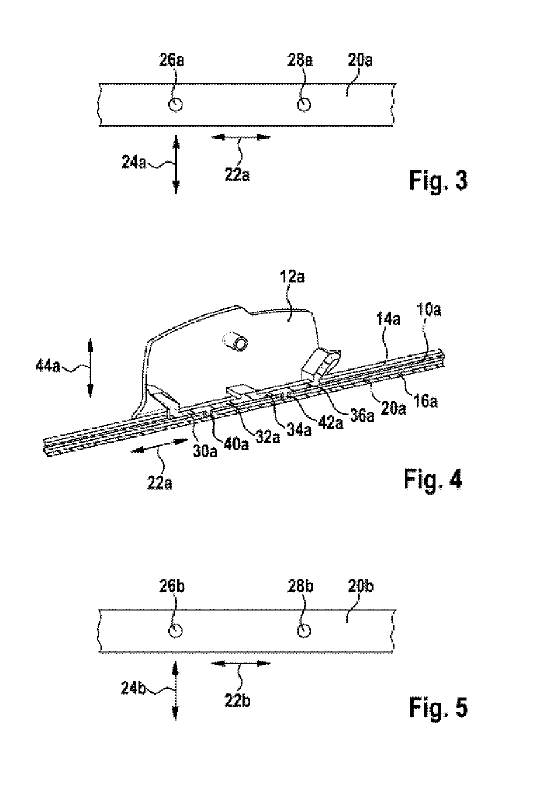

FIG. 3 shows a top view of the spring element 20a. The spring element 20a has two round latching recesses 26a, 28a. The latching recesses 26a, 28a are of circular design. The latching recesses 26a, 28a are arranged one behind the other, as viewed in the longitudinal direction 22a, wherein imaginary centers of the latching recesses 26a, 28a are arranged on a plane of symmetry of the spring element 20a that extends perpendicularly to a wiping direction 24a of the wiping device. A respective diameter of the latching recesses 26a, 28a corresponds to a third of the overall extent of the spring element 20a in the wiping direction 24a.

FIG. 4 illustrates the wiper blade adapter 12a, the retaining element 10a and the spring element 20a in a section. The wiper blade adapter 12a has two latching elements 40a, 42a. The two latching elements 40a, 42a engage in an interlocking manner in the latching recesses 26a, 28a of the spring element 20a in a fitted state and thus avoid a movement of the wiper blade adapter 12a relative to the spring element 20a in the longitudinal direction 22a. The two latching elements 40a, 42a here bear against the spring element 20a on a side facing away from the wiper strip.

The latching elements 40a, 42a in each case have two latching arms 30a, 32a, 34a, 36a which are connected to the wiper blade adapter 12a and are provided to be deflected in a spring-elastic manner. The two latching arms 30a, 32a extend in a main extent parallel to the longitudinal direction 22a of the spring element 20a. The latching elements 40a, 42a are in each case deflectable about two pivot axes which extend parallel to a wiping direction 24a. The latching elements 40a, 42a extend continuously from the latching arms 30a, 32a in the direction of the wiper strip 16a.

During installation, the latching elements 40a, 42a are initially deflected from an initial position in a vertical direction 44a in a spring-elastic manner. The vertical direction 44a extends perpendicularly to the longitudinal direction 22a and perpendicularly to the wiping direction 24a. In an operating state, the vertical direction 44a is therefore at least substantially perpendicular to a surface (not illustrated) to be wiped. As soon as the latching elements 40a, 42a are deflected, the wiper blade adapter 12a is pushed in the longitudinal direction 22a onto the retaining element 10a and onto the spring element 20a inserted in the retaining element 10a. When the latching elements 40a, 42a are above the latching recesses 26a, 28a, the latching elements engage in an interlocking manner in the latter. A movement of the spring element 20a relative to the wiper blade adapter 12a in the longitudinal direction 22a is therefore avoided.

Three further exemplary embodiments of the invention are shown in FIGS. 5 to 10. The descriptions below are substantially limited to the differences between the exemplary embodiments, wherein reference can be made to the description of the first exemplary embodiment with regard to components, features and functions which remain the same. To differentiate between the exemplary embodiments, the letter a in the reference numbers of the exemplary embodiment in FIGS. 1 to 4 is replaced by the letters b to d in the reference numbers of the exemplary embodiments of FIGS. 5 to 10. Reference can in principle also be made to the drawings and/or the description of the first exemplary embodiment with regard to components which are identically denoted, in particular with regard to components with the same reference numbers.

FIG. 5 shows a top view of a spring element 20b of a further exemplary embodiment of a wiping device. The spring element 20b has two round latching recesses 26b, 28b. The latching recesses 26b, 28b are of circular design. The latching recesses 26b, 28b are arranged one behind the other, as viewed in the longitudinal direction 22b, wherein imaginary centers of the latching recesses 26b, 28b are arranged on a plane of symmetry of the spring element 20b that extends perpendicularly to a wiping direction 24b of the wiping device. A respective diameter of the latching recesses 26b, 28b corresponds to a third of the overall extent of the spring element 20b in the wiping direction 24b.

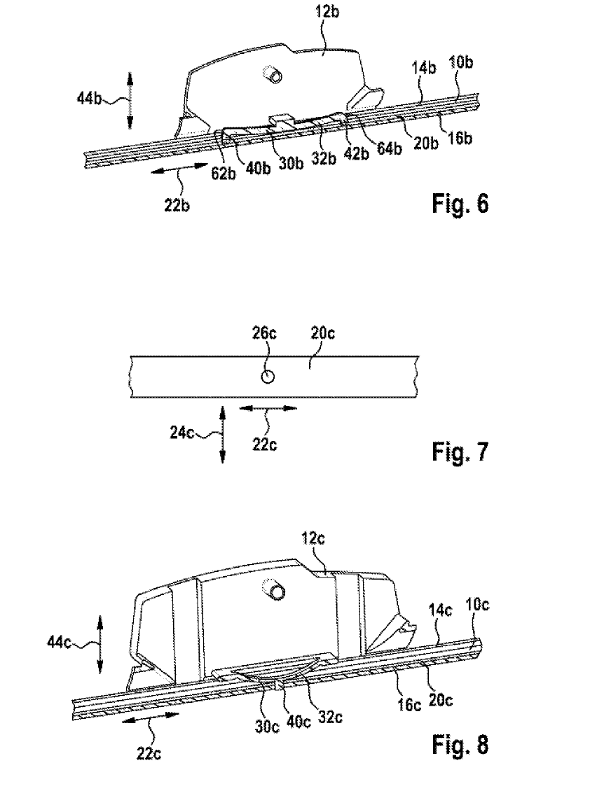

FIG. 6 illustrates a wiper blade adapter 12b, a retaining element 10b and the spring element 20b in a section. The retaining element 10b has a cross section as shown in FIG. 2. The wiper blade adapter 12b has two latching elements 40b, 42b. The two latching elements 40b, 42b engage in an interlocking manner in the latching recesses 26b, 28b of the spring element 20b in a fitted state and thus avoid a movement of the wiper blade adapter 12b relative to the spring element 20b in the longitudinal direction 22b. The two latching elements 40b, 42b here bear against the spring element 20b on a side facing away from the wiper strip.

The latching elements 40b, 42b in each case have a latching arm 30b, 32b which is connected to the wiper blade adapter 12b at one end and is provided to be deflected in a spring-elastic manner. The two latching arms 30b, 32b extend in a main extent parallel to the longitudinal direction 22b of the spring element 20b. The latching elements 40b, 42b are deflectable about in each case about a common pivot axis which extends parallel to a wiping direction 24b. The latching elements 40b, 42b extend continuously from the latching arms 30b, 32b in the direction of a wiper strip 16b. Free latching arm ends 62b, 64b of the latching arms 30b, 32b point in directions facing away from each other.

During installation, the latching elements 40b, 42b are initially deflected in a spring-elastic manner from an initial position in a vertical direction 44b. The vertical direction 44b extends perpendicularly to the longitudinal direction 22b and perpendicularly to the wiping direction 24b. In an operating state, the vertical direction 44b is therefore at least substantially perpendicular to a surface (not illustrated) to be wiped. As soon as the latching elements 40b, 42b are deflected, the wiper blade adapter 12b is pushed in the longitudinal direction 22b onto the retaining element 10b and onto the spring element 20b inserted in the retaining element 10b. When the latching elements 40b, 42b are located above the latching recesses 26b, 28b, said latching elements engage in an interlocking manner in the latter. A movement of the spring element 20b relative to the wiper blade adapter 12b in the longitudinal direction 22b is therefore avoided.

FIG. 7 shows a top view of a spring element 20c of a further exemplary embodiment of a wiping device. The spring element 20c has precisely one round latching recess 26c. The latching recess 26c is of circular design. An imaginary center of the latching recess 26c is arranged on a plane of symmetry of the spring element 20c that extends perpendicularly to a wiping direction 24c of the wiping device. A diameter of the latching recess 26c corresponds to a third of the overall extent of the spring element 20c in the wiping direction 24c.

FIG. 8 illustrates a wiper blade adapter 12c, a retaining element 10c and the spring element 20c in a section. The retaining element 10c has a cross section as shown in FIG. 2. The wiper blade adapter 12c has precisely one latching element 40c. The latching element 40c engages in an interlocking manner in the latching recess 26c of the spring element 20c in a fitted state and thus avoids a movement of the wiper blade adapter 12c relative to the spring element 20c in the longitudinal direction 22c. The latching element 40c here bears against the spring element 20c on a side facing away from the wiper strip.

The latching element 40c has two latching arms 30c, 32c which are in each case connected to the wiper blade adapter 12c at one end and are provided to be deflected in a spring-elastic manner. The two latching arms 30c, 32c extend in a main extent parallel to the longitudinal direction 22c of the spring element 20c. The latching element 40c is deflectable about a pivot axis which extends parallel to a wiping direction 24c. The latching element 40c extends continuously from the latching arms 30c, 32c in the direction of a wiper strip 16c.

During installation, the latching element 40c is initially deflected from an initial position in a spring-elastic manner in a vertical direction 44c. The vertical direction 44c extends perpendicularly to the longitudinal direction 22c and perpendicularly to the wiping direction 24c. In an operating state, the vertical direction 44c is therefore at least substantially perpendicular to a surface (not illustrated) to be wiped. As soon as the latching element 40c is deflected, the wiper blade adapter 12c is pushed in the longitudinal direction 22c onto the retaining element 10c and onto the spring element 20c inserted in the retaining element 10c. When the latching element 40c is located over the latching recess 26c, the latching element engages in an interlocking manner in the latter. A movement of the spring element 20c relative to the wiper blade adapter 12c in the longitudinal direction 22c is therefore avoided.

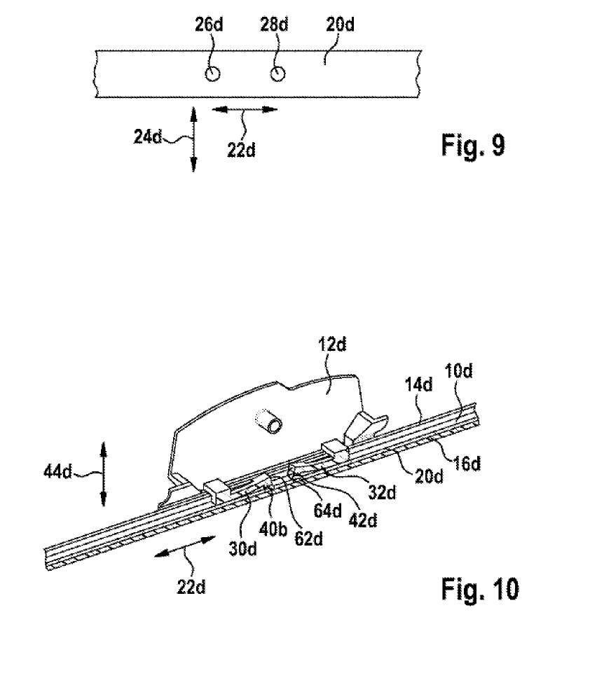

FIG. 9 shows a top view of a spring element 20d of a further exemplary embodiment of a wiping device. The spring element 20d has two round latching recesses 26d, 28d. The latching recesses 26d, 28d are of circular design. The latching recesses 26d, 28d are arranged one behind the other, as seen in the longitudinal direction 22d, wherein imaginary centers of the latching recesses 26d, 28d are arranged on a plane of symmetry of the spring element 20d that extends perpendicularly to a wiping direction 24d of the wiping device. A respective diameter of the latching recesses 26d, 28d corresponds to a third of the overall extent of the spring element 20d in the wiping direction 24d.

FIG. 10 illustrates a wiper blade adapter 12d, a retaining element 10d and the spring element 20d in a section. The retaining element 10d has a cross section as shown in FIG. 2. The wiper blade adapter 12d has two latching elements 40d, 42d. The two latching elements 40d, 42d engage in an interlocking manner in the latching recesses 26d, 28d of the spring element 20d in a fitted state and thus avoid a movement of the wiper blade adapter 12d relative to the spring element 20d in the longitudinal direction 22d. The two latching elements 40d, 42d here bear against the spring element 20d on a side facing away from the wiper strip.

The latching elements 40d, 42d in each case have a latching arm 30d, 32d which is connected to the wiper blade adapter 12d at one end and is provided to be deflected in a spring-elastic manner. The two latching arms 30d, 32d extend in a main extent parallel to the longitudinal direction 22d of the spring element 20d. The latching elements 40d, 42d are in each case deflectable about a dedicated pivot axis which extends parallel to the wiping direction 24d. The latching elements 40d, 42d extend continuously from the latching arms 30d, 32d in the direction of a wiper strip 16d. Free latching arm ends 62d, 64d of the latching arms 30d, 32d point in directions facing each other.

During installation, the latching elements 40d, 42d are initially deflected from an initial position in a spring-elastic manner in a vertical direction 44d. The vertical direction 44d extends perpendicularly to the longitudinal direction 22d and perpendicularly to the wiping direction 24d. In an operating state, the vertical direction 44d is therefore at least substantially perpendicular to a surface (not illustrated) to be wiped. As soon as the latching elements 40d, 42d are deflected, the wiper blade adapter 12d is pushed in the longitudinal direction 22d onto the retaining element 10d and onto the spring element 20d inserted in the retaining element 10d. When the latching elements 40d, 42d are located above the latching recesses 26d, 28d, said latching elements engage in an interlocking manner in the latter. A movement of the spring element 20d relative to the wiper blade adapter 12d in the longitudinal direction 22d is therefore avoided.

1. A wiping device, comprising a spring element (20a-20d) and comprising a wiper blade adapter (12a-12d) which has at least one latching element (40a-40d, 42a-42d), characterized in that the spring element (20a-20d) has at least one round latching recess (26a-26d, 28a-28d) in which the at least one latching element (40a-40d, 42a-42d) engages in an interlocking manner in a fitted state and avoids a movement of the wiper blade adapter (12a-12d) relative to the spring element (20a-20d) in a longitudinal direction (22a-22d).

2. The wiping device as claimed in claim 1, further comprising a wiper strip, characterized in that, in the fitted state, the at least one latching element (40a-40d, 42a-42d) bears against the at least one spring element (20a-20d) on a side facing away from the wiper strip.

3. The wiping device as claimed in claim 1, characterized in that the at least one latching element (40a-40d, 42a-42d) is deflected at least substantially in a vertical direction (44a-44d) during installation.

4. The wiping device as claimed in claim 1, characterized in that the at least one latching element (40a; 40c, 42a) has at least two latching arms (30a; 30c, 32a; 32c, 34a, 36a) which are connected to the wiper blade adapter (12a; 12c) and are deflected in a spring-elastic manner.

5. The wiping device as claimed in claim 4, characterized in that the at least two latching arms (30a; 30c, 32a; 32c, 34a, 36a) extend in a main extent at least substantially parallel to the longitudinal direction (22a; 22c) of the spring element (20a; 20c).

6. The wiping device as claimed in claim 1, characterized in that the wiper blade adapter (12b) has two latching elements (40b, 42b), free latching arm ends (62b, 64b) of which point in directions facing away from each other.

7. The wiping device as claimed in claim 1, characterized in that the wiper blade adapter (12d) comprises two latching elements (40d, 42d), free latching arm ends (62b, 64b) of which point in directions facing each other.

8. The wiping device as claimed in claim 1, characterized in that the at least one latching element (40a-40d, 42a; 42b; 42d) is deflectable about at least one pivot axis which extends parallel to a wiping direction (24a-24d).

9. A spring element (20a-20d) of a wiping device as claimed in claim 1.

10. A wiper blade adapter (12a-12d) of a wiping device as claimed in claim 1.

11. A wiper blade comprising a wiper blade adapter (12a-12d) and a spring element (20a-20d) as claimed in claim 1, and further comprising a wind spoiler element (14a-14d), a retaining element (10a-10d) and a wiper strip (16a-16d).

12. The wiper blade as claimed in claim 11, characterized in that, in the fitted state, the at least one latching element (40a-40d, 42a-42d) bears against the at least one spring element (20a-20d) on a side facing away from the wiper strip.

13. The wiper blade as claimed in claim 11, characterized in that the at least one latching element (40a-40d, 42a-42d) is deflected at least substantially in a vertical direction (44a-44d) during installation.

14. The wiper blade as claimed in claim 11, characterized in that the at least one latching element (40a; 40c, 42a) has at least two latching arms (30a; 30c, 32a; 32c, 34a, 36a) which are connected to the wiper blade adapter (12a; 12c) and are deflected in a spring-elastic manner.

15. The wiper blade as claimed in claim 14, characterized in that the at least two latching arms (30a; 30c, 32a; 32c, 34a, 36a) extend in a main extent at least substantially parallel to the longitudinal direction (22a; 22c) of the spring element (20a; 20c).

16. The wiper blade as claimed in claim 11, characterized in that the wiper blade adapter (12b) has two latching elements (40b, 42b), free latching arm ends (62b, 64b) of which point in directions facing away from each other.

17. The wiper blade as claimed in claim 11, characterized in that the wiper blade adapter (12d) comprises two latching elements (40d, 42d), free latching arm ends (62b, 64b) of which point in directions facing each other.

18. The wiper blade as claimed in claim 11, characterized in that the at least one latching element (40a-40d, 42a; 42b; 42d) is deflectable about at least one pivot axis which extends parallel to a wiping direction (24a-24d).
